(19) United States
(12) Patent Application Publication
(10) Pub. No.: US 2009/0030761 A1
(43) Pub. Date: Jan. 29, 2009

(54) PREDICTING FINANCIAL IMPACT OF BUSINESS FRAMEWORK

(75) Inventors: Kannan Amaresh, Bangalore (IN); Vinayak Arun Kini, Bangalore (IN); Sumanta Deb, Bangalore (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 12/170,388

(22) Filed: Jul. 9, 2008

(30) Foreign Application Priority Data
Jul. 9, 2007 (IN) 1474/CHE/2007

(51) Int. Cl. G06Q 10/00

(52) U.S. Cl. 705/7

(57) ABSTRACT

The financial impact of the implementation of a business framework can be predicted. Shifted business condition metrics associated with business activities for implementing the business framework can be applied to model financial impact for a business entity. Impact on financial condition according to income statement and balance sheet can be modeled based on financial data for the business entity. Impact can be modeled per activity. Activities can be prioritized based on modeled impact.

### FIELD

The technical field relates generally to financial modeling, and more specifically to a prediction of the impact of a business framework on a business entity.

### BACKGROUND

In a quickly changing business environment, companies need additional tools to help remain competitive. One such tool is a business framework to enable successful competition in a “flat” world. The flat world is characterized by:

1. Opening up of emerging economies (e.g., redistribution of global wealth in favor of emerging economies)

2. Structural shift in global demographics (e.g., integration of more than two billion potential customers in the world market; emergence of India and China as key sources of talent)

3. Ubiquity of technology (e.g., drastic improvements in technology and connectivity)

4. Accountability regulation (e.g., growing complexity in terms of regulations related to security and privacy)

To succeed in such a world, paradigm shifts can be addressed (e.g., China Price, Make Money from Information, Loyalty through Innovation, and Winning in Turns).

However, there remains a need for more effective application of a business framework according to such paradigm shifts.

### SUMMARY

The methods and systems relate generally to financial modeling of a business framework, and, more particularly, on modeling the financial impact of the business framework on a business entity.

In accordance with one aspect, a method to model the financial impact of the implementation of a business framework for a business entity is disclosed.

Per-activity modeling can be implemented.

Shifted business condition metrics can be used to model adoption or improvement of business activities.

Business activities can be prioritized based on modeled impact if the activities were to be adopted or improved.

As described herein, a variety of other features and advantages can be incorporated into the technologies as desired.

The foregoing and other features and advantages will become more apparent from the following detailed description, which proceeds with reference to the accompanying drawings.

### BRIEF DESCRIPTION OF THE FIGURES

FIG. 1 is a diagram showing an exemplary internal representation of a business framework, including relationships between activities.

FIG. 2 is a block diagram showing exemplary relationships between represented business activities and shifted business condition metrics.

FIG. 3 is a block diagram showing exemplary relationships between business condition metrics and shifted business condition metrics.

FIGS. 4A-C are block diagrams showing exemplary calculation of financial impact via business condition metrics, financial condition, and shifted business condition metrics.

FIG. 5 is a block diagram showing exemplary relationships between shifted business condition metrics and an activity.

FIG. 6 is a block diagram of an exemplary system configured to implement the modeling techniques described herein.

FIG. 7 is a flowchart of an exemplary method implementing a modeling technique.

FIG. 8 is a block diagram of an exemplary system configured to model financial impact on a plurality of financial condition elements that is combined into an aggregated modeled financial impact.

FIG. 9 is a flowchart of an exemplary method of aggregating impact on financial condition elements into an aggregated modeled financial impact.

FIG. 10 is a block diagram of an exemplary system configured to implement the modeling techniques described herein by individual activity.

FIG. 11 is a flowchart of an exemplary method implementing a modeling technique for plural activities.

FIG. 12 is a block diagram of an exemplary system configured to prioritize activities.

FIG. 13 is a flowchart of an exemplary method of prioritizing activities.

FIG. 14 is a flowchart depicting process actions in one embodiment.

FIG. 15 is a diagram illustrating components of financial model of a business entity under a business framework in one embodiment.

FIG. 16 is a diagram illustrating the linkage between activities and metrics of a business entity under a business framework in one embodiment.

FIG. 17 is a spreadsheet depicting the user input interface for accepting user-specific inputs for financials of each of the metric and improvements in the metrics respectively in one embodiment.

FIG. 18 is a spreadsheet page summarizing the financial impact of each activity on income statement, balance sheet, and total financial cash flow in one embodiment.

FIG. 19 is a spreadsheet page summarizing the financial impact of all the activities on income statement, balance sheet, and total financial cash flow in one embodiment.

FIG. 20 is a spreadsheet page summarizing the prioritized activities that a business entity needs to take up based on the recasted income statement, balance sheet, and total cash flow in one embodiment.

FIG. 21 is an exemplary spreadsheet page implementing modeling for the sub-shift “satisfy customers unmet needs.”

FIG. 22 is a block diagram of an exemplary suitable computing environment for implementing any of the methods or systems described herein.

### DETAILED DESCRIPTION

### Example 1

### Exemplary Overview

The following description is a full and informative description of the best method and system presently contemplated for carrying out the claimed modeling techniques that is known to the inventors at the time of filing the patent application. While the methods described herein are provided with a certain degree of specificity, the present techniques may be implemented with either greater or lesser specificity, depending on the needs of the user. Further, some of the features may be used to advantage without the corresponding use of other features described in the following paragraphs. As such, the present description should be considered as merely illustrative of principles and not limiting.

### Example 2

### Exemplary Advantages

Upstart companies, in a fast changing business environment, can use new business models with which they can compete with established incumbents and give them a run for their money by challenging them to speed up, slim down, and become more nimble.

Therefore, companies strive to adopt the business framework, which will enable them to compete successfully in a “flattening” business environment or in a business environment that is being dramatically transformed by the confluence of disruptive forces.

To implement a business framework, a company needs to perform certain key activities differently from its competitors to succeed in the business environment. The highest level groups of such activities in the business framework are called “paradigm shifts.” In the examples herein, the business framework can comprise four paradigm shifts (e.g., China Price, Make Money from Information, Loyalty through Innovation, and Winning in Turns).

The shifts comprise respective sets of one or more sub-shifts that break down the high level shifts into a more granular level. The sub-shifts comprise respective groups of one or more operational activities at company level called “activities” or “business activities.” Activities are the possible actions that a company needs to take up at operational level to compete in the business environment.

The business framework further has metrics that can be used to measure the performance of the activities. Each activity can have more than one metric. The data to measure where a company stands vis-à-vis each metric is available with the company. The metrics for the industry in which the company operates (e.g., business environment) are typically available from public sources.

From time to time, businesses perform financial planning as a critical activity for managing cash flow and communicating the financial condition of the business to its stakeholders. For new businesses, the preparation of financial projections is integral to the business planning process. For larger companies, financial planning forms part of annual budgeting and plays an important role in long-term planning, business appraisals, corporate development, and the like.

In the context of the described business framework, there is need for a financial model that would help a company to prioritize the activities by using financial metrics as the criteria for prioritization. Accordingly, there is a need for a financial model to predict the impact of the implementation of the business framework within the business entity in a business environment to enable companies to compete successfully in a flattening business world. Also, there is a need for the ability to assess the financial benefits in terms of cash flow of adopting this business framework and prioritize inter-se amongst the various activities that the company could take up under the framework.

### Example 3

### Exemplary Financial Modeling

Financial modeling of a business framework can be achieved, and modeling can predict the financial impact of implementing a business framework (e.g., business actions defined within the framework) on a business entity.

### Example 4

### Exemplary Business Environment

A business environment can include the socioeconomic environment in which business entities operate. A business environment can be defined locally (e.g., a small area or a city) or over a larger area (e.g., a country or the whole world).

### Example 5

### Exemplary Business Entity

A business entity can include a group of people organized for some profitable or charitable purpose. Business entities can include organizations such as corporations, partnerships, charities, trusts, and other forms of organization. Typically, a business entity maintains accounting records that can be used for modeling as described herein.

### Example 6

### Exemplary Business Framework

A business framework can include a hierarchy of paradigm shifts and business activities and can be used to guide management of a business entity so that the business entity and its business partners can work efficiently and effectively, both individually and collectively, and succeed for mutual benefit.

In any of the examples herein, the business framework can be a global paradigm realignment business framework that specifies paradigm shifts associated with a global paradigm realignment.

### Example 7

### Exemplary Paradigm Shift

A shift refers to the highest level of grouping of business activities that a business entity can perform (e.g., differently from other business entities) to compete in a flattening business environment.

A sub-shift refers to the next lower level under shift.

### Example 8

### Exemplary Activities

Business activities are the actions that a business entity can take up at an operational level. Such activities can improve performance for competing in a flattening business environment. The business activities can be chosen to be mutually exclusive (e.g., it is possible to take up any of them individually). The business activities can also be collectively exhaustive with respect to the business activities for competing in a flat world (e.g., as defined in the business framework).

### Example 9

### Exemplary Metrics

A business condition metric can be a measure of any business-related condition within a business entity. A business condition metric can also be a business condition within a business environment.

### Example 10

### Exemplary Shifted Business Condition Metrics

A shifted business condition metric is a measure of any business-related condition within a business entity and can be assigned an expected (e.g., “shifted”) value if a particular business activity within the framework were to be adopted or improved by the business entity.

The business condition metrics that are shifted and the business activities themselves can be defined so that they are mutually exclusive (e.g., it is possible to observe the impact of the activity based on one or more metrics associated with the activity, and no metric is associated with more than one activity).

In practice, a shifted business condition metric has an associated (e.g., corresponding) business condition metric that has an observed value (e.g., without having been shifted). The observed, un-shifted business condition metric is sometimes called a “base case.”

The shifted business condition metric can be assigned a value that represents an improvement over the base case of the business condition metric. The value can be assigned by an analyst in light of industry practice, industry trends, business entity characteristics, and other research or information. Modeling of financial impact due to the improvement can be performed as described herein.

### Example 11

### Exemplary Business Condition Metric Benchmarks

In any of the examples herein, benchmarks can be specified for business condition metrics. If available, such benchmarks can assist in analysis by informing choice of values for shifted business condition metrics.

### Example 12

### Exemplary Financial Condition

In any of the examples herein, a financial condition of a business entity can be the condition as indicated in past or projected data (e.g., an income statement, balance sheet, cash flow statement, or the like) and is typically a combination of financial condition elements.

In any of the examples herein, the financial condition can include financial condition elements of a business entity, the business environment of the business entity, or both. In addition to or instead of past financial condition, future projected financial condition (e.g., based on current assumptions without implementing the business framework) can also be included in financial condition in any of the examples herein.

### Example 13

### Exemplary Financial Condition Elements

In any of the examples herein a financial condition element can be any observed or projected data (e.g., an accounting line item indicating a percentage, dollar amount, Euro amount, or the like) indicating the financial condition of the business entity. For example, financial condition elements can include revenues, cost of sales, gross margin, operating expenses, profit for the year, and the like.

In any of the examples herein, financial condition elements can be any line item (e.g., dollar or other currency amount) on an income statement, balance sheet, or the like. Modeling financial impact typically comprises modeling impact on values for one or more financial condition elements. The financial condition elements can then be aggregated to determine total impact on balance sheet, income statement, cash flow, or combinations thereof.

### Example 14

### Exemplary Relationship Between Shifted Business Condition Metrics and Business Activities

To achieve modeling, a business activity can be associated with one or more shifted business condition metrics. Financial condition and business condition metrics can be collected for a particular business entity and compared to shifted business condition metrics in combination with current financial condition to model impact on financial condition elements, which reflect impact on financial condition of the business entity.

The associated shifted business condition metrics can also be defined as indicators of how effectively their respective business activities are performed.

### Example 15

### Exemplary Representation of Business Framework

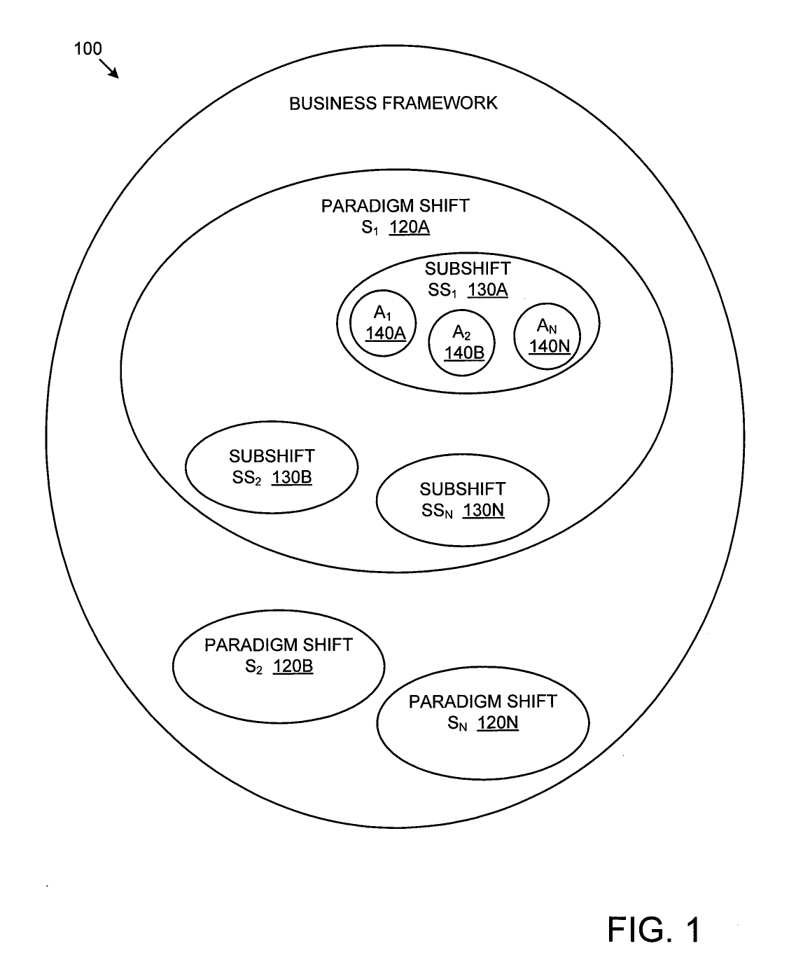

FIG. 1 is a diagram showing an exemplary internal representation 100 of a business framework, including relationships between activities. Such a representation can be useful in software when modeling financial impact.

In the example, the business framework representation 100 is an aggregate of a plurality of paradigm shifts 120A-N. Shifts 120A-N can have a plurality of respective associated sub-shifts 130A-130N. Sub-shifts can have a plurality of respective associated activities 140A-140N. In practice, the representation can be more complex, representing any number of activities.

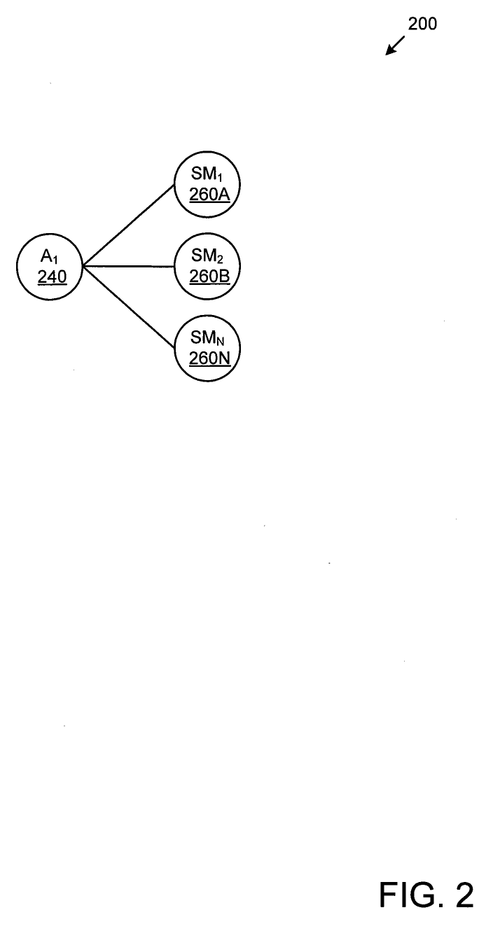

FIG. 2 is a block diagram showing a representation 200 of business activities and shifted business condition metrics, and relationships between them, and can be used in conjunction with the arrangement of FIG. 1. In any of the examples herein, a business activity 240 can be represented as associated with one or more shifted business condition metrics 260A-N. For example, when an analysis of whether the activity 240 is adopted or improved by a business entity, the metrics 260A-N can be considered (e.g., the difference between the shifted business condition metrics and observed base cases).

The shifted business condition metrics can be unique per activity. In other words, activities and shifted metrics can be defined so that no activities share a shifted business condition metric (e.g., the shifted metric is applied only when modeling the activity, not when modeling other activities). If so, an activity can have more than one shifted metric, but no metric is shared by plural activities. Such an arrangement can facilitate isolation of impact and ability to measure effectiveness of the activity. If more than one activity in the framework could be related to a shifted metric, the activities can be considered as a single logical activity.

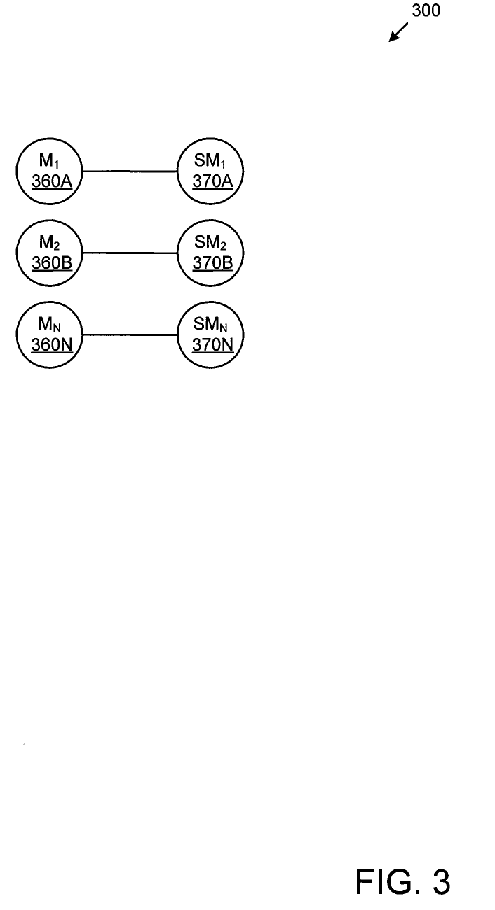

FIG. 3 is a block diagram showing relationships between business condition metrics 360A-N and shifted business condition metrics 370A-N (e.g., shift values that are targeted with adoption of an activity). The shifted business condition metrics 370A-N can be used to evaluate provided values for the metrics 360A-N (e.g., the difference between an observed “base case” value and a shifted value).

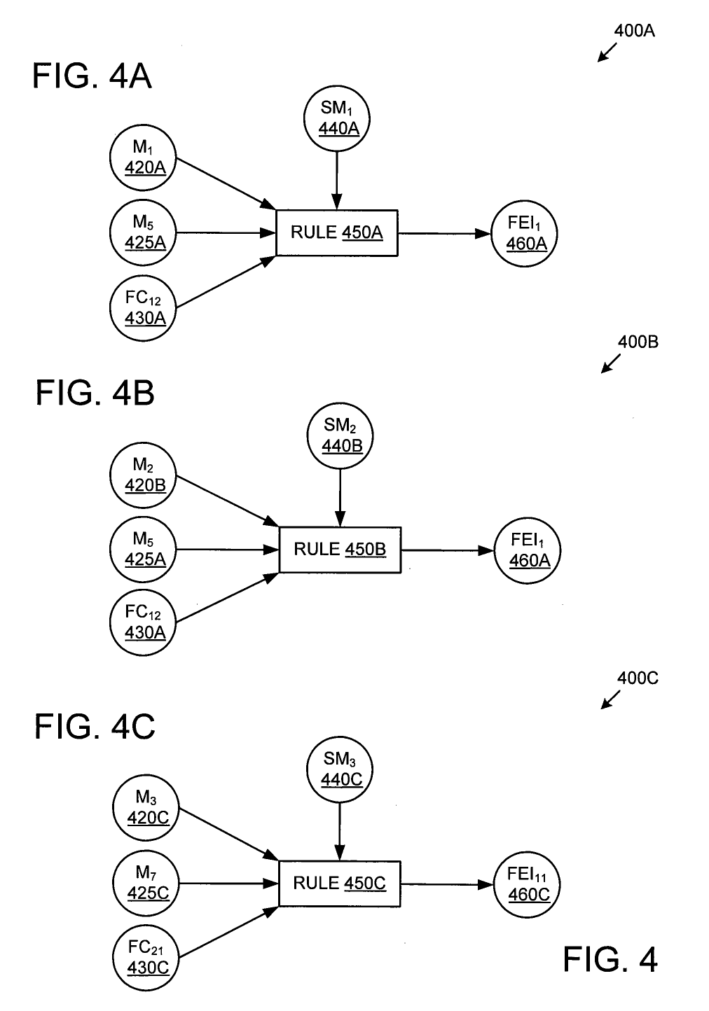

FIGS. 4A-C are block diagrams showing exemplary calculation of financial impact via business condition metrics, financial condition, and shifted business condition metrics; the shown arrangement can be used in any of the examples herein. In the exemplary arrangement, the models 400A, 400B, and 400C are for respective different activities. It is possible to have more than one model per activity (e.g., to calculate impact on different financial condition elements). However, as shown in the examples, a shifted metric is peculiar to an activity (e.g., no shifted metric appears in any model for more than one activity). In this way, a shifted business condition metric is exclusive to a respective single activity.

In the example model 400A, one or more business condition metrics 420A, 425A and one or more financial conditions 430A serve as input, along with a shifted business condition metric 440A that corresponds to (e.g., is the shifted version of a base case) one of the other inputs 420A; the rule 450A outputs impact on a financial condition element 460A.

In FIG. 4B, in a similar arrangement of model 400B, one or more business condition metrics 420B, 425A and one or more financial conditions 430A serve as input, along with a shifted business condition metric 440B (e.g., a shifted version of the observed base case metric 420B); the rule 450B outputs impact on a financial condition element 460A. Note that while the inputs are the same (except for the shifted metric and its base case) and the output types are the same as that in model 400A, the output value for the output 460A by the rule 450B can be different than the output value for 460A.

In FIG. 4C, in a similar arrangement of model 400C, one or more business condition metrics 420C, 425C and one or more financial conditions 430C serve as input, along with a shifted business condition metric 440C (e.g., a shifted version of the corresponding observed base case metric 420C); the rule 450C outputs impact on a financial condition element 460C.

In the examples, a rule takes as input both the shifted business condition metric and the corresponding observed base case (e.g., non-shifted) business condition metric. Other inputs (e.g., additional metrics, financial conditions, or both) can be included for the rule.

### Example 16

### Exemplary Determination of Activity Performance

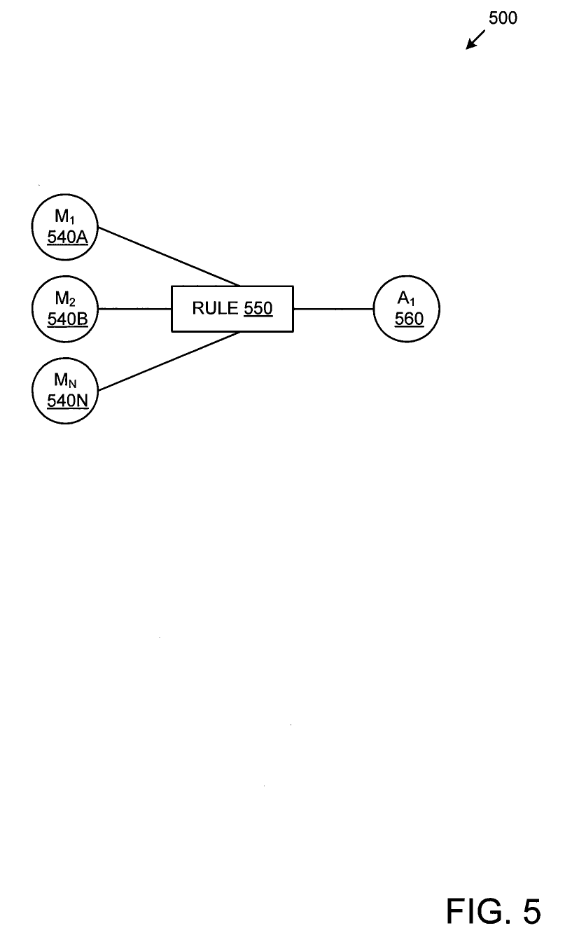

FIG. 5 is a block diagram showing an internal representation 500 of relationships between metrics 540A-N and a business activity 560. In the example, the metrics 540A-N are base cases of corresponding shifted business condition metrics.

In practice, a rule 550 can take observed business condition metrics 540A-N for a business entity as input and output an approximation of how well the activity 560 is being performed within the organization.

### Example 17

### Exemplary System Employing a Combination of the Technologies

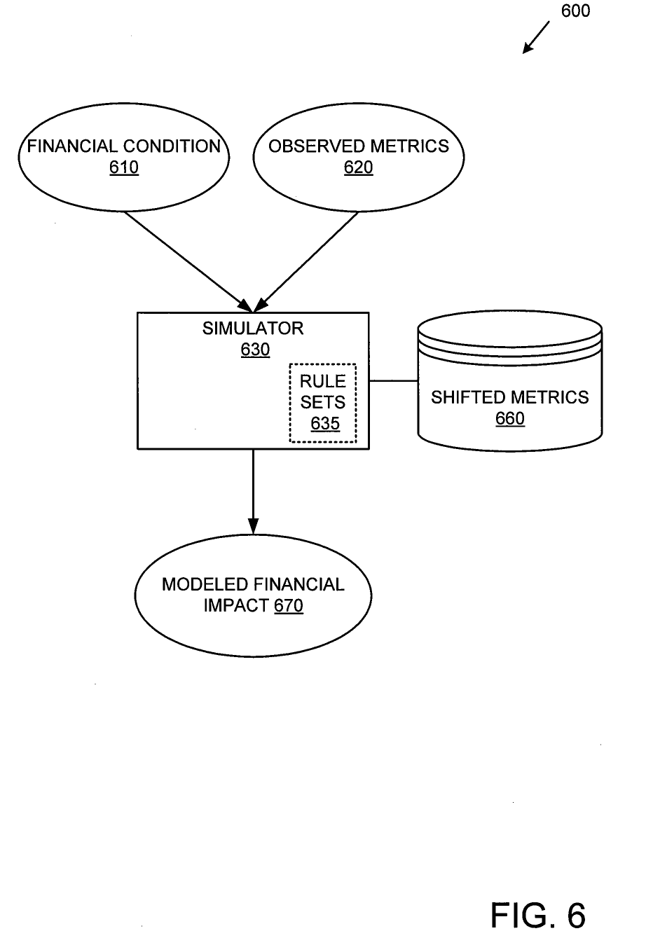

FIG. 6 is a block diagram of an exemplary system 600 for modeling financial impact of implementation of a business framework on a financial entity.

In the example, a simulator 630 accepts the financial condition 610 of the business entity and observed base cases for business condition metrics 620 and applies the rule sets 635 in light of the shifted business condition metrics 660 to generate a modeled financial condition 670.

In practice, the system 600 can be more complicated, with additional functionality, more inputs, additional data sources, and the like.

### Example 18

### Exemplary Method Employing a Combination of the Technologies

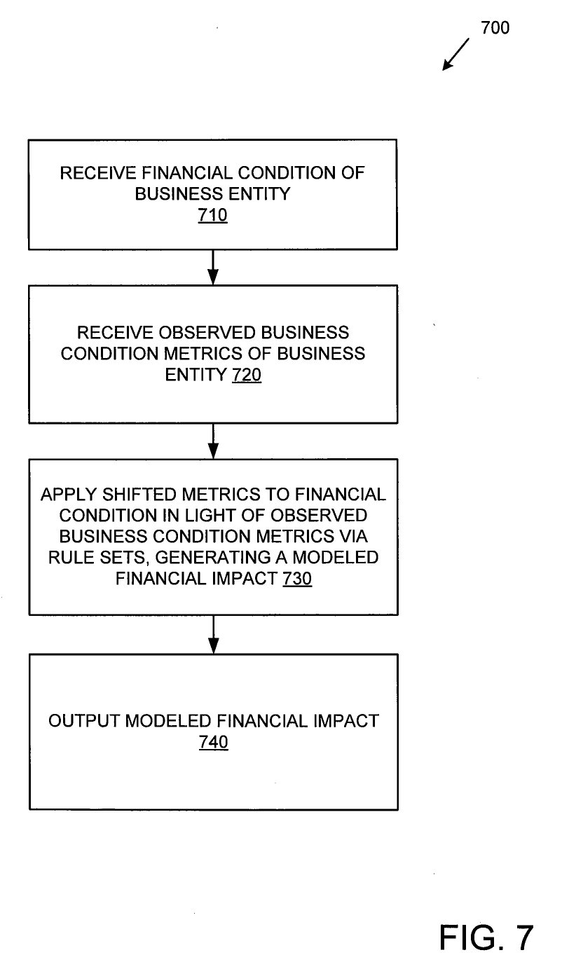

FIG. 7 is flowchart of a method 700 implementing a modeling technique and can be used in any of the examples herein.

In the example, at 710, the financial condition of a business entity is received. For example, financial condition elements can be received. Financial condition of the business environment in which the business entity operates can also be received.

At 720, observed business condition metrics of the business entity can be received.

At 730, shifted business condition metrics are applied to the financial condition in light of observed business condition metrics (e.g., via rule sets), generating modeled financial impact.

At 740, the modeled financial impact is output.

The method 700 and any of the methods described herein can be performed by computer-executable instructions stored in one or more computer-readable media (e.g., storage or other tangible media).

### Example 19

### Exemplary System Aggregating Financial Impact

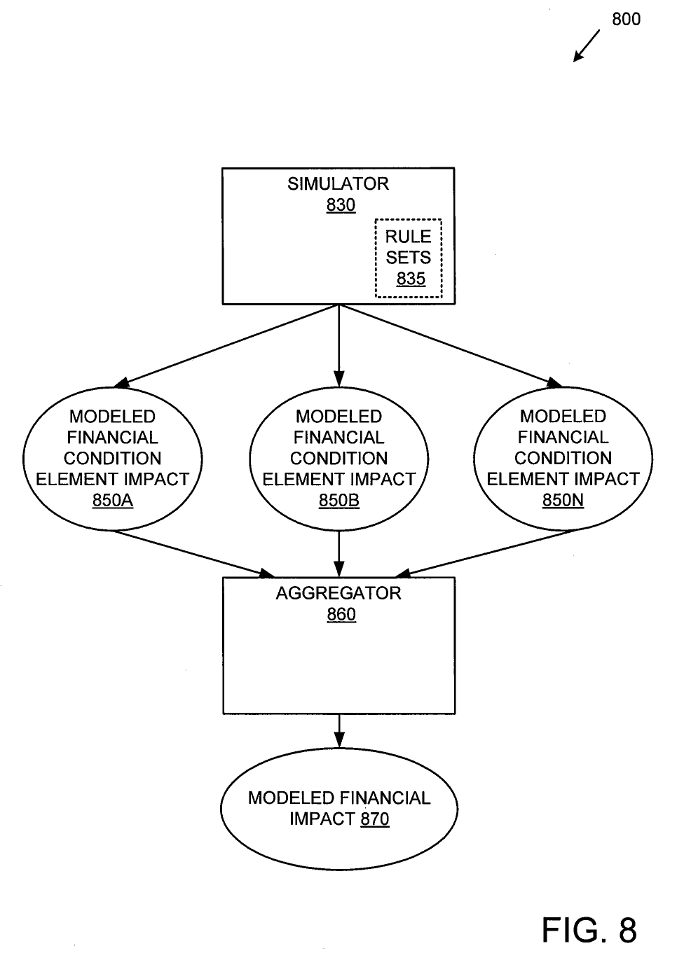

In any of the examples herein, a system can generate modeled financial impact via aggregation of impact on plural modeled financial condition elements. FIG. 8 is a block diagram of an exemplary system 800 configured to model financial impact of a plurality of financial condition elements 850A-N that are combined into an aggregated modeled financial impact 870.

In the example, a simulator 830 generates a plurality of values 850A-N for modeled financial condition element impact (e.g., according to respective rule sets 835). An aggregator 860 is configured to accept the impact 850A-N as input and outputs a modeled financial impact 870. The aggregated impact can be combined elements of a balance sheet or income statement. For example, the impact of one element can be to increase expenses, while the impact of another element is to decrease expenses. The two can thus offset each other, resulting in a net impact. The same elements can be impacted, or different elements can be impacted. In any case, an income statement or balance sheet (e.g., the bottom line thereof) can be affected accordingly.

### Example 20

### Exemplary Method of Aggregating Financial Impact

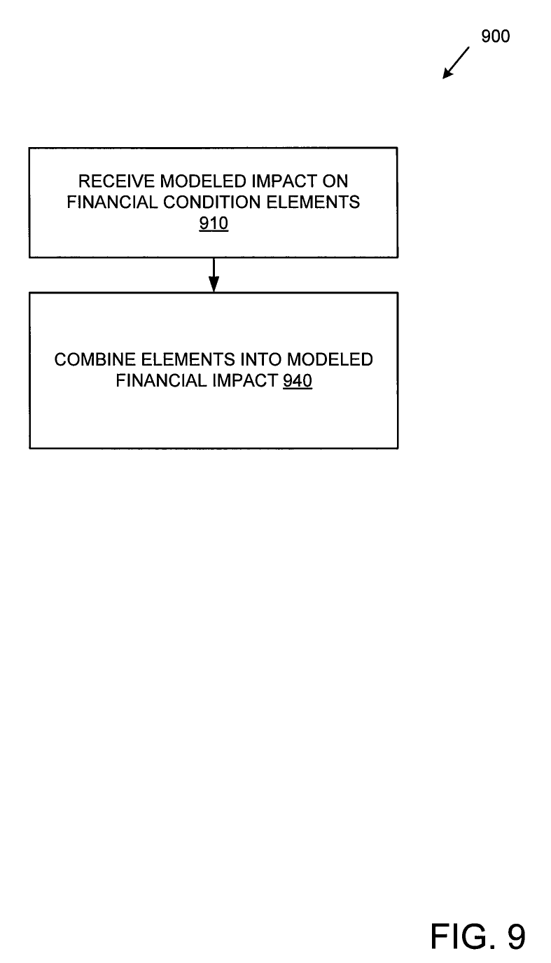

In any of the examples herein, financial impact can be generated by combining impact on plural financial condition elements. FIG. 9 is a flowchart of an exemplary method of aggregating impact on financial condition elements into an aggregated modeled financial impact.

In the example, at 910, modeled impact on a plurality of financial condition elements is received. At 940, the impact on the elements is combined into an aggregated modeled financial impact.

### Example 21

### Exemplary System Implementing Per-Activity Modeling of Financial Impact

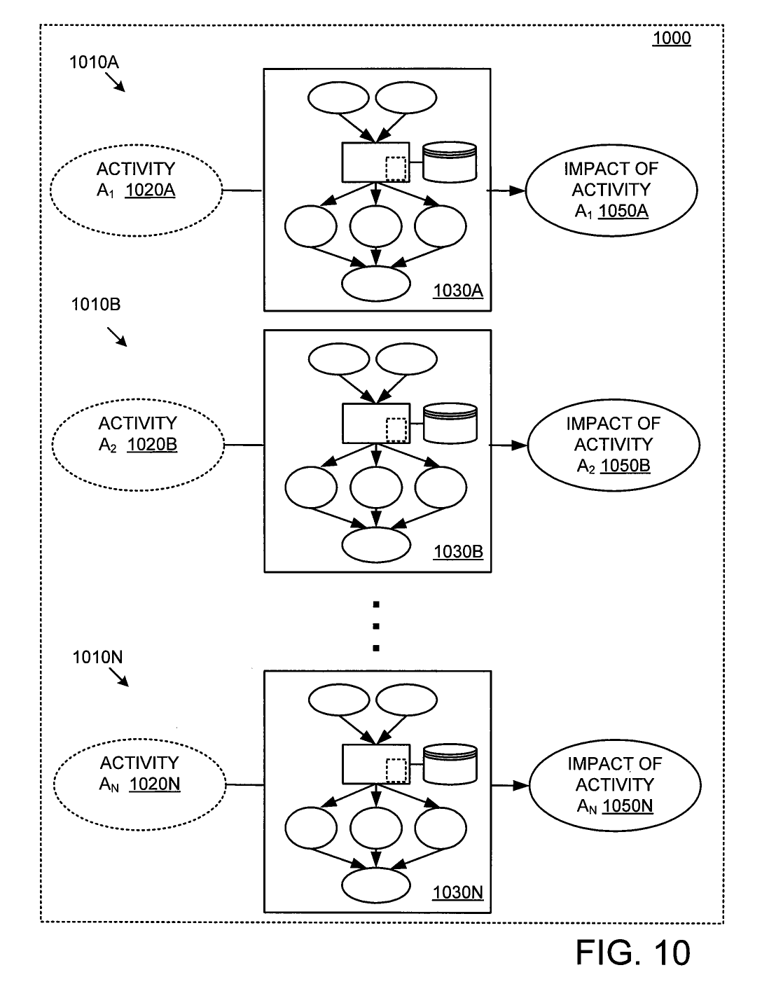

In any of the examples herein, per-activity modeling can be performed. FIG. 10 is a block diagram of a system 1000 configured to implement the modeling techniques described herein by individual activity. In the example, in effect, a plurality of systems 1010A-N model the impact 1050A-N of adopting respective modeled business activities 1020A-N via models 1030A-N. In practice, some inputs for the models 1030A-N can be shared. However, shifted business condition metrics can be defined as exclusive to respective activities (e.g., serve as inputs only for rules modeling a single particular activity). As described herein, the impact on different financial condition elements of an activity can be aggregated to determine total financial impact.

The systems 1030A-N can be implemented as any of the systems described herein, such as that shown in FIG. 6.

However, the impact (e.g., aggregated) of respective separate activities can be stored as respective separate results that can be separately considered, prioritized, ranked, or the like.

### Example 22

### Exemplary Method of Per-Activity Modeling of Financial Impact

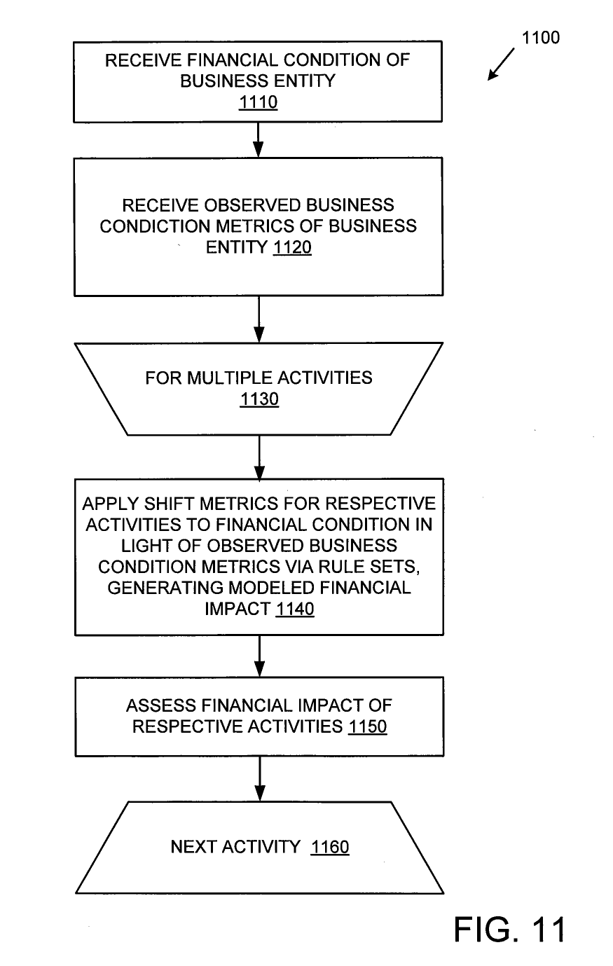

FIG. 11 is a flowchart of a method implementing a modeling technique 1100 for plural activities. In the example, the financial condition of a business entity is received at 1110. Conditions of the business environment can also be included.

At 1120, the observed business condition metrics of the business entity are received.

At 1130, processing for a plurality of activities is performed.

At 1140, shifted business condition metrics for respective activities are applied to the financial condition of the business entity in light of observed business condition metrics via rule sets, generating a modeled financial impact if the activity were to be adopted or improved.

At 1150, the impact of the respective activity is assessed (e.g., the activity's effect on financial condition as modeled is stored).

At 1160, the next activity is considered, and processing continues at action 1140.

### Example 23

### Exemplary System for Prioritizing Activities

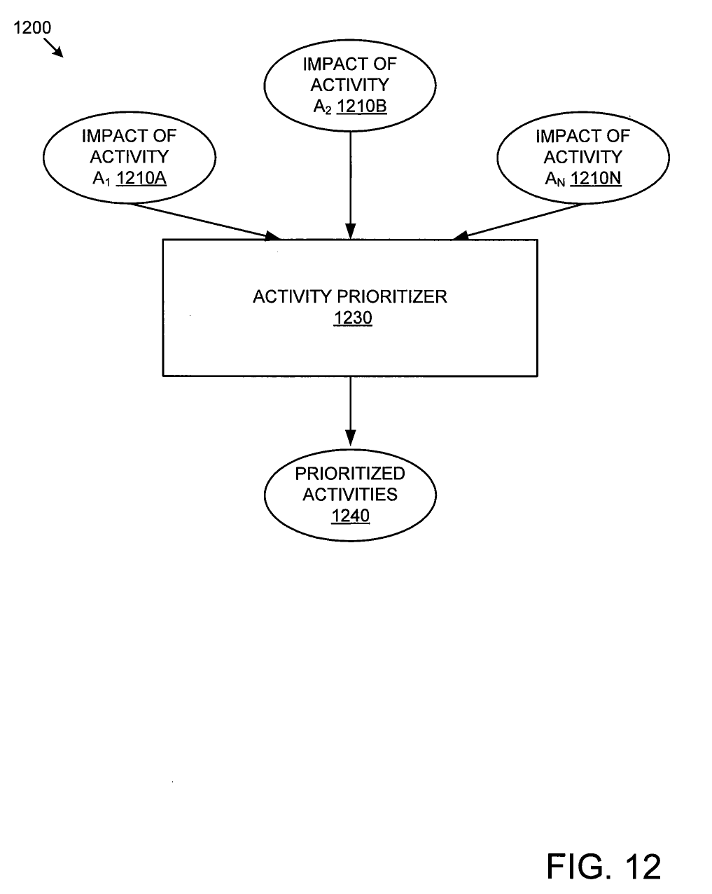

FIG. 12 is a block diagram of a system 1200 configured to prioritize activities. In the example, an activity prioritizer 1230 accepts impact of respective activities 1210A-N and outputs prioritized activities 1240.

The output can take the form of those activities (e.g., ranked, cut-off, or both) having the most favorable impact. For example, the most favorable impact on financial condition (e.g., balance sheet, income statement, cash flow, or the like). The impact on a bottom line of the financial condition can be considered during prioritization.

The prioritizer can be used in a system configured to recommend which of the activities to undertake. For example, the top n (e.g., 5) activities based on financial impact can be output as those recommended to be considered for adoption or improvement. For flexibility, the top n activities based on impact on balance sheet can be output as well as the top n activities based on impact on income statement.

Prioritization can be used in any of the examples herein. In such an arrangement, the activities can be considered as candidate activities that may be considered for implementation or improvement by the business entity. Prioritization can assist in determining which of the many possible candidate activities are to be considered. A proper subset (e.g., subset having fewer members than the set) of the business activities can be output for consideration (e.g., based on priority).

### Example 24

### Exemplary Method of Prioritizing Activities

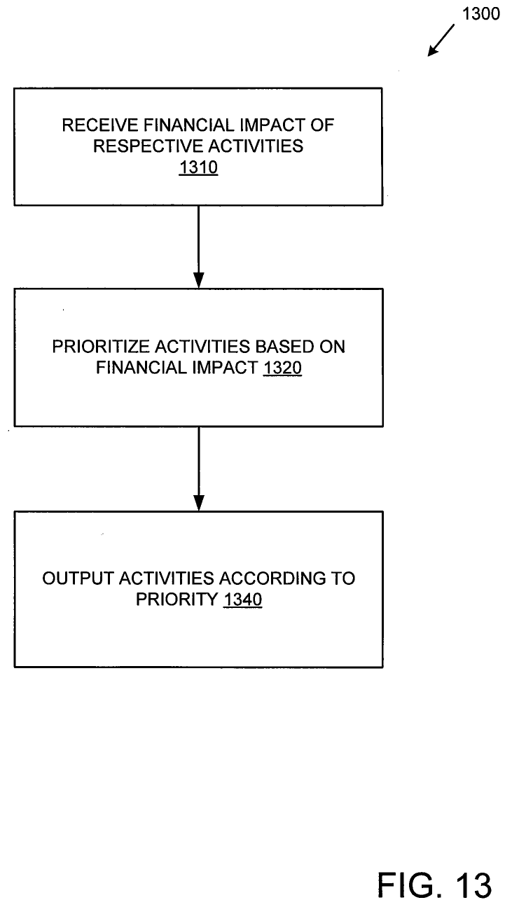

FIG. 13 is a flowchart of an exemplary method of prioritizing activities. In the example, the financial impact of respective activities is received at 1310. At 1320, the activities are prioritized based on financial impact. At 1340, the activities are output according to priority. For example, the activities can be ranked based on which activities have the most favorable impact.

The method can be used to recommend which of the activities to undertake. For example, the top n (e.g., 5) activities based on financial impact can be output as those recommended to be adopted. For flexibility, the top n activities based on impact on balance sheet can be output as well as the top n activities based on impact on income statement.

### Example 25

### Exemplary Sub-Shifts

In any of the examples herein, the sub-shifts shown in Table 1 can be used. As shown, the sub-shifts can be associated with respective paradigm shifts in a business framework adapted to address a flat world.

TABLE 1
Exemplary Sub-shifts

| Paradigm Shift | Sub-shift |
|---|---|
| Loyalty Through Innovation | 1. Satisfy customers unmet needs |
| | 2. Bring product to market faster |
| | 3. Enhance internal operations |
| Make Money from Information | 4. Revenue enhancement |
| | 5. Cost efficiency |
| China Price | 6. Leverage global skilled talent |
| | 7. Implement global sourcing 2.0 |
| | 8. Target new market opportunities |
| Winning in Turns | 9. Predictive capabilities |
| | 10. Flexible business models |
| | 11. Adaptive operating strategies |

### Example 26

### Exemplary Activities

In any of the examples herein, the business activities shown in Table 2 can be used. The business activities can be those chosen from within the business framework adapted to address a flat world. Activities can be combined into a single logical activity to preserve exclusivity of shifted business condition metrics.

TABLE 2
Exemplary Business Activities

| | |
|---|---|
| 1. | Look outside to open networks as well as the firm's ecosystem for |
| | product/service ideas |
| 2. | Involve customer in co-creation activities |
| 3. | Institutionalize a rigorous process to select a winning product/service |
| | concept |
| 4. | Identify and eliminate innovation bottlenecks |
| 5. | Create the right structure, physical space and technology platform for |
| | effective collaboration |
| 6. | Leverage “Open Innovation Networks” to access talents and |
| | technologies |
| 7. | Use skill in emerging markets |
| 8. | Develop metric to measure innovation effectiveness |
| 9. | Take actions to continuously improve the innovation process |
| 10. | Build analytics and tools to customize interaction with customers |
| | Customize offerings |
| | Cross sell and up sell |
| 11. | Use low cost global talents to mine customer information to gain a |
| | larger share of customer's wallet |
| 12. | Use real time data and analytics to drive supply chain and working |
| | capital management decisions |
| 13. | Create a platform and tool set to enable information sharing and |
| | analysis across the value chain for effective collaboration and |
| | decision making |
| 14. | Ensure information flows to the right parties at the right time |
| 15. | Develop global talent footprint to match organization needs |
| 16. | Source knowledge work globally |
| 17. | Structure organizations to optimally work across geographies |
| 18. | Disaggregate & modularize the value chain to source from |
| | networks of suppliers |
| 19. | Centralize capability & relationship based sourcing decisions |
| 20. | Target emerging markets to achieve economies of scale and scope |
| 21. | Leverage global cost structure to target value segment in developed |
| | markets |
| 22. | Develop a system for timely acquisition, processing and |
| | dissemination of forecasting information for decision making |
| 23. | Build business cycle literacy capabilities & decision tools |
| 24. | Implement an organization structure that encourages business cycle |
| | management |
| 25. | Design modularized processes for quick ramp up/down |
| 26. | Deploy a low fixed and high variable cost structure by outsourcing |
| | and off shoring non core activities |
| 27. | Re-engineer and automate processes to make them business cycle |
| | independent |
| 28. | Rebalance product and geographic mix to align with market |
| | conditions |
| 29. | Align working capital and cap ex strategy for competitive advantage |
| 30. | Apply hedging strategies to minimize exposure |

### Example 27

### Exemplary Metrics

In any of the examples herein, the business condition metrics shown in Table 3 can be used. Some of the business condition metrics can also serve as corresponding shifted business condition metrics.

TABLE 3
Exemplary Metrics

| | |
|---|---|
| 1. | % of revenues through alliances |
| 2. | % of revenues through IP acquisition [new services/products |
| | launched or synergized] |
| 3. | % gross margin in sales through alliances |
| 4. | % gross margin in sales through IP acquisitions |
| 5. | % sales and marketing expenses in alliances |
| 6. | % general and administrative expenses alliances |
| 7. | Days accounts receivables alliances |
| 8. | % of sales of customized products |
| 9. | % sales growth in customized products |
| 10. | % gross margin from sales of customized products |
| 11. | % sales and marketing expenses for customized products |
| 12. | % general and administrative expenses for customized products |
| 13. | Days accounts receivable for customized products |
| 14. | % Successful products developed |
| 15. | % Improvement in success rate translatable into sales |
| 16. | Product development cycle time in months |
| 17. | Product launch time in months |
| 18. | Product launch expenses as % of sales and marketing |
| 19. | % Cost overruns in new product development per month |
| 20. | % Time overruns in new product development |
| 21. | Research and development expenses that are a function of time |
| 22. | Number of products developed from internal operations |
| 23. | % of sales occurring from products developed through internal |
| | operations |
| 24. | Number of products sold per customer |
| 25. | Revenue per customer per product |
| 26. | Number of customers (million) |
| 27. | Sales returns/Total Sales |
| 28. | % sales and marketing expenses bundled products |
| 29. | Full time equivalents |
| 30. | Sales and marketing expenses per FTE ($) |
| 31. | General and administrative expenses per FTE ($) |
| 32. | % of back orders to total orders |
| 33. | % attrition of orders on account of back orders |
| 34. | % repeat orders/total orders |
| 35. | % sales and marketing expenses on repeat orders |
| 36. | No of research and development employees |
| 37. | No of sales and marketing employees |
| 38. | No of general and administrative employees |
| 39. | Average annual cost of research and development FTE in mature |
| | markets |
| 40. | Average annual cost of sales and marketing FTE in mature markets |
| 41. | Average annual cost of general and administrative FTE in mature |
| | markets |
| 42. | Average annual cost of research and development FTE in emerging |
| | markets |
| 43. | Average annual cost of sales and marketing FTE in emerging markets |
| 44. | Average annual cost of general and administrative FTE in emerging |
| | markets |
| 45. | % of research and development employees in emerging markets |
| 46. | % of sales and marketing employees in emerging markets |
| 47. | % of general and administrative employees in emerging markets |
| 48. | % of Total Cost of sales paid to external suppliers |
| 49. | % gross margin on COGS to external suppliers |
| 50. | % of Research and Development expenses paid to external suppliers |
| 51. | % Research and development expenses when outsourced |
| 52. | % of Sales and Marketing expenses paid to external suppliers |
| 53. | % Sales and Marketing expenses when outsourced |
| 54. | % of General and Administrative expenses paid to external suppliers |
| 55. | % General and Administrative expenses when outsourced |
| 56. | % revenue from emerging markets |
| 57. | % gross margin in emerging markets |
| 58. | % sales and marketing expenses in emerging markets |
| 59. | Accounts receivables in emerging markets days sales |
| 60. | % sales in value segment (previous year) |
| 61. | % growth in sales in value segment |
| 62. | % gross margin in sales to value segment |
| 63. | % sales and marketing expenses in value segment |
| 64. | Accounts receivables in value segment |
| 65. | Turn in sales (negative) |
| 66. | % of cost of sales variable |
| 67. | % of research and development variable |
| 68. | % sales and marketing variable |
| 69. | % general and administrative variable |
| 70. | % annual increase in fixed cost of sales |
| 71. | % annual increase in fixed research and development |
| 72. | % annual increase in fixed sales and marketing |
| 73. | % annual increase in fixed general and administrative |
| 74. | % revenue through bundled product sales |

### Example 28

### Exemplary Relationship between Activities, Shifted Metrics, and Financial Condition Elements

In any of the examples herein, business activities can be associated with one or more respective shifted business condition metrics, which impact one or more financial condition elements. In any of the examples herein, the cash flow impact can be the sum of various elements from the income statement impact, cash flow impact, or both.

TABLE 4A
Exemplary Activity/Shifted Metric/Financial Condition Element
Associations
(Satisfy customers unmet needs)

| | | Financial Condition |
|---|---|---|
| Activity | Shifted Metric(s) | Elements Impacted |
| Look outside to | 1. % of revenues through | Income Statement: |
| open networks as | alliances (shift case) | 1. Decrease/(Increase) in |
| well as the firm's | 2. % of revenues through | cost of sales |
| ecosystem for | IP acquisition [new | 2. Increase/(Decrease) in |
| product/service | services/products | gross margin |
| ideas | launched or synergized] | 3. Decrease/(Increase) in |
| | | sales and marketing |
| | | expenses |
| | | 4. Decrease/(Increase) in |
| | | general and |
| | | administrative expenses |
| | | Balance Sheet: |
| | | 1. Decrease/(Increase) in |
| | | accounts receivable |
| Involve customer in | % of sales of customized | Income Statement: |
| co-creation | products (shift case) | 1. Decrease/(Increase) in |
| activities | | sales |
| | | 2. Decrease/(Increase) in |
| | | cost of sales |
| | | 3. Increase/(Decrease) in |
| | | gross margin |
| | | 4. Decrease/(Increase) in |
| | | sales and marketing |
| | | expenses |
| | | 5. Decrease/(Increase) in |
| | | general and |
| | | administrative expenses |
| | | Balance Sheet: |
| | | 1. Decrease/(Increase) in |
| | | accounts receivable |
| Institutionalize a | % Successful products | Income Statement: |
| rigorous process to | developed (shift case) | 1. Decrease/(Increase) in |
| select a winning | | sales |
| product/service | | 2. Decrease/(Increase) in |
| concept | | cost of sales |
| | | 3. Increase/(Decrease) in |
| | | gross margin |
| | | 4. Increase/(Decrease) in |
| | | research and |
| | | development expenses |
| | | 5. Decrease/(Increase) in |
| | | sales and marketing |
| | | expenses |
| | | 6. Decrease/(Increase) in |
| | | general and |
| | | administrative expenses |
| | | Balance Sheet: |
| | | 1. Decrease/(Increase) in |
| | | accounts receivable |

TABLE 4B
Exemplary Activity/Shifted Metric/Financial Condition Element
Associations
(Bring product to market faster)

| | | Financial Condition |
|---|---|---|
| Activity | Shifted Metric(s) | Elements Impacted |
| Identify and | 1. Product development | Income Statement: |
| eliminate innovation | cycle time in months | 1. Decrease/(Increase) in |
| bottlenecks | (shift case) | research and |
| | 2. Product launch time in | development expenses |
| | months (shift case) | 2. Decrease/(Increase) in |
| | | sales and marketing |
| | | expenses |

TABLE 4C
Exemplary Activity/Shifted Metric/Financial Condition Element
Associations
(Enhance internal operations)

| | | Financial Condition |
|---|---|---|
| Activity | Shifted Metric(s) | Elements Impacted |
| Develop metrics to | 1. % Cost overruns in | Income Statement: |
| measure innovation | new product | 1. Decrease/(Increase) in |
| effectiveness | development per month | sales |
| | (shift case) | 2. Decrease/(Increase) in |
| | 2. % Time overruns in | cost of sales |
| | new product | 3. Increase/(Decrease) in |
| | development (shift case) | gross margin |
| | 3. Number of products | 4. Increase/(Decrease) in |
| | developed from internal | research and |
| | operations (shift case) | development expenses |
| | | 5. Decrease/(Increase) in |
| | | sales and marketing |
| | | expenses |
| | | 6. Decrease/(Increase) in |
| | | general and |
| | | administrative expenses |
| | | Balance Sheet: |
| | | 1. Decrease/(Increase) in |
| | | accounts receivable |

TABLE 4D
Exemplary Activity/Shifted Metric/Financial Condition Element
Associations
(Revenue enhancement)

| | | Financial Condition |
|---|---|---|
| Activity | Shifted Metric(s) | Elements Impacted |
| Build analytics and | 1. Number of products | Income Statement: |
| tools to customize | sold per customer (shift | 1. Decrease/(Increase) in |
| interaction with | case) | sales |
| customers | | |
| Customize offerings | 2. Revenue per customer | 2. Decrease/(Increase) in |
| Cross sell and | per product (shift case) | cost of sales |
| up sell | 3. Sales returns/Total | 3. Increase/(Decrease) in |
| | Sales (shift case) | gross margin |
| | 4. % revenue through | 4. Decrease/(Increase) in |
| | bundled product sales | sales and marketing |
| | (shift case) | expenses |
| | | 5. Decrease/(Increase) in |
| | | general and |
| | | administrative expenses |
| | | Balance Sheet: |
| | | 1. Decrease/(Increase) in |
| | | accounts receivable |

TABLE 4E
Exemplary Activity/Shifted Metric/Financial Condition Element
Associations
(Cost efficiency)

| | | Financial Condition |
|---|---|---|
| Activity | Shifted Metric(s) | Elements Impacted |
| Use real time data and | 1. Inventory turns per | Balance Sheet: |
| analytics to drive supply | year (shift case) | 1. Decrease/(Increase) in inventory |
| chain and working capital | 2. Receivables days sales | |
| management decisions | (shift case) | 2. Decrease/(Increase) |
| | 3. Accounts payable | in accounts receivable |
| | days cost of goods sold | 3. Increase/(Decrease) |
| | (shift case) | in accounts payable |
| Create a platform and tool | 1. % saving in warranty | Income Statement: |
| set to enable information | costs per widget | 1. Decrease/(Increase) in |
| sharing and analysis across | 2. % saving in warranty | cost of sales |
| the value chain for | management costs per | 2. Increase/(Decrease) in |
| effective collaboration and | widget | gross margin |
| decision making | | 3. Decrease/(Increase) in |
| | | general and |
| | | administrative expenses |
| Ensure information flows | 1. % of back orders to | Income Statement: |
| to the right parties at the | total orders (shift case) | 1. Decrease/(Increase) in |
| right time | 2. % of repeat orders to | sales |
| | total orders (shift case) | 2. Decrease/(Increase) |
| | | in cost of sales |
| | | 3. Increase/(Decrease) in |
| | | gross margin |
| | | 4. Decrease/(Increase) in |
| | | sales and marketing |
| | | expenses |
| | | Balance Sheet: |
| | | 1. Decrease/(Increase) in |
| | | accounts receivable |

TABLE 4F
Exemplary Activity/Shifted Metric/Financial Condition Element
Associations
(Leverage global skilled talent)

| | | Financial Condition |
|---|---|---|
| Activity | Shifted Metric(s) | Elements Impacted |
| Develop global | 1. Increasing overheads | Income Statement: |
| talent footprint to | on account of shift to | 1. Decrease/(Increase) in |
| match organization | emerging markets (shift | research and |
| needs | case) | development expenses |
| | 2. % of research and | 2. Decrease/(Increase) |
| | development employees | in sales and marketing |
| | in emerging markets | expenses |
| | (shift case) | 3. Increase/(Decrease) in |
| | 3. % of sales and | general and |
| | marketing employees in | administrative expenses |
| | emerging markets (shift | |
| | case) | |
| | 4. % of general and | |
| | administrative | |
| | employees in emerging | |
| | markets (shift case) | |

TABLE 4G
Exemplary Activity/Shifted Metric/Financial Condition Element
Associations
(Implement global sourcing 2.0)

| | | Financial Condition |
|---|---|---|
| Activity | Shifted Metric(s) | Elements Impacted |
| Disaggregate & | 1. % of Total Cost of | Income Statement: |
| modularize the | sales paid to external | 1. Decrease/(Increase) in |
| value chain to | suppliers (shift case) | cost of sales |
| source from | 2. % of Research and | 2. Increase/(Decrease) in |
| networks of | Development expenses | gross margin |
| suppliers | paid to external suppliers | 3. Decrease/(Increase) in |
| | (shift case) | research and |
| | 3. % of Sales and | development expenses |
| | Marketing expenses paid | 4. Decrease/(Increase) in |
| | to external suppliers | sales and marketing |
| | (shift case) | expenses |
| | 4. % of General and | 5. Decrease/(Increase) in |
| | Administrative expenses | general and |
| | paid to external suppliers | administrative expenses |
| | (shift case) | Balance Sheet: |
| | | 1. Increase/(Decrease) in |
| | | accounts payable |

TABLE 4H
Exemplary Activity/Shifted Metric/Financial Condition Element
Associations
(Target new market opportunities)

| | | Financial Condition |
|---|---|---|
| Activity | Shifted Metric(s) | Elements Impacted |
| Target emerging markets | 1. % revenue from | Income Statement: |
| to achieve economies of | emerging markets | 1. Decrease/(Increase) in |
| scale and scope | (shift case) | cost of sales |
| | | 2. Increase/(Decrease) in |
| | | gross margin |
| | | 3. Decrease/(Increase) in |
| | | sales and marketing |
| | | expenses |
| | | Balance Sheet: |
| | | 1. Decrease/(Increase) in |
| | | accounts receivable |
| Leverage global cost | 1. % sales growth in | Income Statement: |
| structure to target value | value segment (shift | 1. Decrease/(Increase) |
| segment in developed | case) | in sales |
| markets | | 2. Decrease/(Increase) in |
| | | cost of sales |
| | | 3. Increase/(Decrease) in |
| | | gross margin |
| | | 4. Decrease/(Increase) in |
| | | sales and marketing |
| | | expenses |
| | | Balance Sheet: |
| | | 1. Decrease/(Increase) in |
| | | accounts receivable |

TABLE 4I
Exemplary Activity/Shifted Metric/Financial Condition Element
Associations
(Predictive capabilities)

| | | Financial Condition |
|---|---|---|
| Activity | Shifted Metric(s) | Elements Impacted |
| Develop a system for | 1. Market Share | Income Statement: |
| timely acquisition, | (shift case) | 1. Decrease/(Increase) in |
| processing and | | sales |
| dissemination of | | 2. Decrease/(Increase) in |
| forecasting information | | cost of sales |
| for decision making | | 3. Increase/(Decrease) in |
| | | gross margin |
| | | 4. Increase/(Decrease) in |
| | | sales and marketing |
| | | expenses |
| | | 5. Decrease/(Increase) |
| | | in general and |
| | | administrative expenses |
| | | Balance Sheet: |
| | | 1. Decrease/(Increase) in |
| | | accounts receivable |
| Build business cycle | 1. Interest | Income Statement: |
| literacy capabilities & | coverage | 1. Decrease/(Increase) in |
| decision tools | times (shift case) | interest expenses |
| | | Balance Sheet: |
| | | 1. Increase/(Decrease) in |
| | | term liabilities |
| Implement an organization | 1. Order book in | Income Statement: |
| structure that encourages | months (shift | 1. Increase/(Decrease) |
| business cycle | case) | in order book |
| management | | 2. Protection of sales |
| | | from turn |
| | | 3. Protection of |
| | | operating profit from |
| | | turn |

TABLE 4J
Exemplary Activity/Shifted Metric/Financial Condition Element
Associations
(Flexible business models)

| | | Financial Condition |
|---|---|---|
| Activity | Shifted Metric(s) | Elements Impacted |
| Deploy a low fixed and | 1. % of cost of sales | Income Statement: |
| high variable cost | variable (shift case) | 1. Decrease/(Increase) in |
| structure by outsourcing | 2. % of research and | cost of sales |
| and off shoring non | development | 2. Increase/(Decrease) in |
| core activities | variable (shift | gross margin |
| | case) | |
| | 3. % sales and | 3. Increase/(Decrease) in |
| | marketing variable | research and |
| | (shift case) | development expenses |
| | 4. % general and | 4. Increase/(Decrease) in |
| | administrative | sales and marketing |
| | variable (shift | expenses |
| | case) | 5. Decrease/(Increase) |
| | | in general and |
| | | administrative expenses |

TABLE 4K
Exemplary Activity/Shifted Metric/Financial Condition Element
Associations
(Adaptive operating strategies)

| | | Financial Condition |
|---|---|---|
| Activity | Shifted Metric(s) | Elements Impacted |
| Align working capital and | 1. Cash Infusion/ | Balance Sheet: |
| cap ex strategy for | Withdrawal | 1. Increase/(Decrease) in |
| competitive advantage | | Equity |
| Apply hedging strategies to | 1. Market beta | Income Statement: |
| minimize exposure | of the company | 1. (Increase)/Decrease in |
| | (shift case) | cost of equity |
| | | 2. (Increase)/Decrease in |
| | | weighted average cost of |
| | | capital |
| | | Balance Sheet: |
| | | 1. Increase/(Decrease) in |
| | | market capitalization |

### Example 29

### Exemplary Implementation

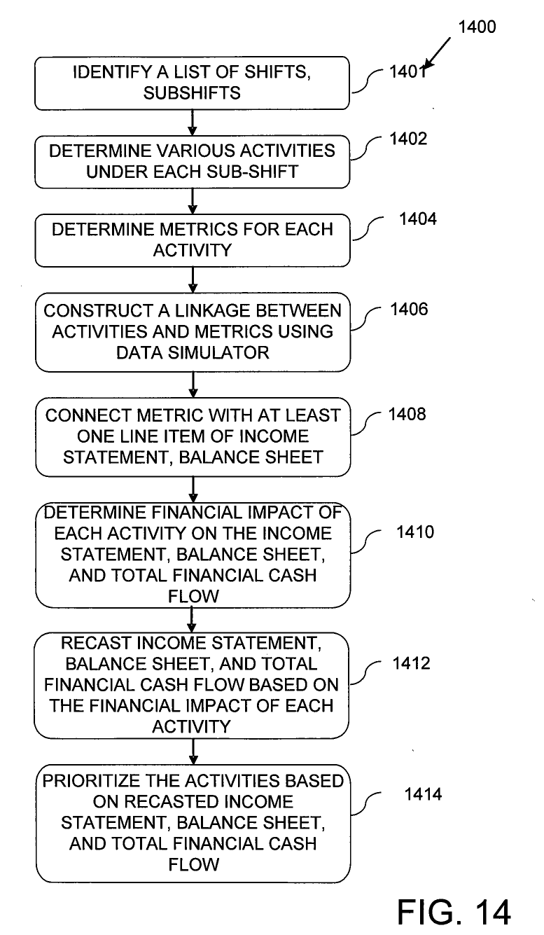

In FIG. 14 there is shown a flowchart of process steps for predicting the financial impact of the implementation of a business framework on a business entity in a business environment in accordance with one embodiment. The method starts at 1400, wherein a list of shifts and sub-shifts are identified for the business framework.

At 1402, various activities for each sub-shift are defined. The activities are the operational actions that a business entity should take up to compete in a flattening business environment.

At 1404, a single or plurality of metrics have been defined for each activity defined at 1402. The premises in defining the metrics have been that: a) the data to measure where a business entity stands vis-à-vis each metric is available within the business entity and b) the metrics for the industry in which the business entity operates are available from public sources. The activities and the metrics are mutually exclusive and collectively exhaustive, i.e., no overlap amongst activities and metrics. At 1406, each activity is linked with one more metrics defined at 1404. In any of the examples, the activities and the metrics can be mutually exclusive and collectively exhaustive, i.e., no overlap amongst activities and metrics so that the system makes it possible to take up any of the metrics individually as well as taking all of the metrics at the same time.

At 1408, each metric is linked to the individual line items in the income statement and the balance sheets that would be impacted. At 1410, the financial impact of each activity is determined on the Income Statement, Balance Sheet and Total Financial Cash Flow. The Income Statement, Balance Sheet and Total Financial Cash Flow are recast based on the financial impact of the each activity at 1412. At 1414, the activities that a business entity needs to perform are prioritized based on the recast Income Statement, Balance Sheet and Total Financial Cash Flow.

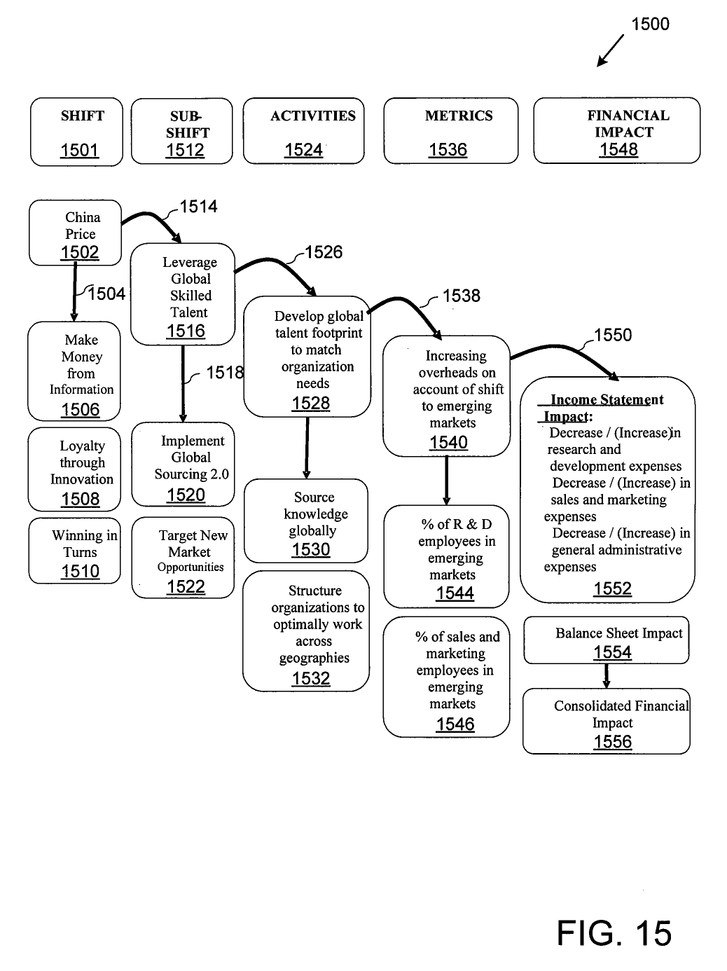

In FIG. 15, a schematic diagram containing the components of the business framework and the linkage between the list of activities and the list of metrics is broadly explained. The business framework starts with a list of shifts 1500. The list of shifts in one embodiment is China price 1502, Make money from Information 1506, Loyalty through Innovation 1508 and Winning in Turns 1510. The sub-shifts in step 1512 are further dropdown to one or more sub-shift for each shift. At 1514, the shift “China Price” is linked to a sub-shift “Leverage Global Skilled Talent” sub-shift 1516. The list of other sub-shifts linked to “China Price” shift via step 1518 is “Implement Global Sourcing 2.0” 1520, “Target New Market Opportunities” 1522. The sub-shifts used in the business environment can be any of the exemplary sub-shifts described herein.

The third column of the model describes a list of activities 1524 taken up at an operational level by a business entity. The linkage as shown via step 1526 is to construct a link between a “Leverage Global Skilled Talent” sub-shift 1516 and list of activities such as “Develop global talent footprint to match organization needs” 1528, “Source Knowledge Globally” 1530 and Structure Organizations to optimally work across geographies” 1532 respectively. The list of activities that a business entity can adopt can be any of the exemplary business activities described herein.

The fourth column of the model defines a measure of how effectively an activity is measured in terms of metrics as shown in 1536. The linkage 1538 adapted to construct a link between an “Develop global talent footprint to match organization needs” activity 1528 to a list of metrics “Increasing overheads on account of shift to emerging markets” 1540, “% of R & D employees in emerging markets” 1544, “% of sales and marketing employees in emerging markets” 1546 respectively. Each of these metrics were linked to one or more line items in the column where financial impact 1548 of these activities is performed. At 1550, the impact of each metric on one or more line items of the income statement 1552, balance sheet 1554, and total financial cash flow 1556 is computed.

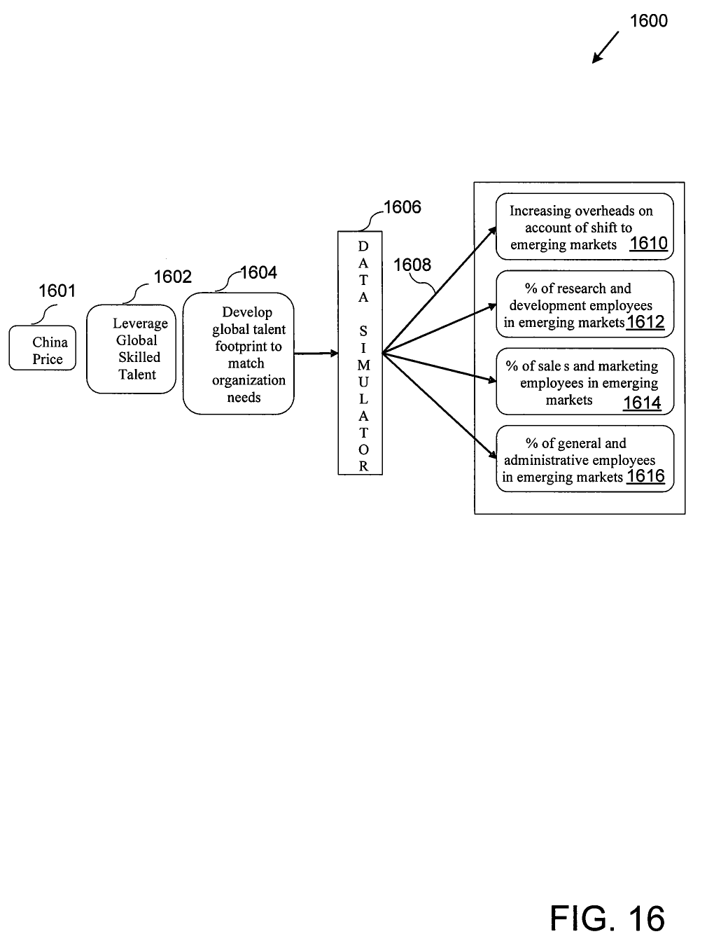

FIG. 16 is an exemplary embodiment to construct a link between the activity and one or more metrics under the business framework. The system starts with defining a shift Component “China Price” 1600 is categorized into a sub-shift Component “Leverage Global Skilled Talent” 1602. The sub-shift Component is further categorized into an Activity “Develop global talent footprint to match organization needs” 1604. Using the Data Simulator 1606, having a predefined rules engine, a link via step 1608 is established between activity 1604 and a list of metrics such as “Increasing overheads on account of shift to emerging markets” 1610, “% of research and development employees in emerging markets”, 1612, “% of sales and marketing employees in emerging markets” 1614 and “% of general and administrative employees in emerging markets” 1616 respectively. The list of metrics considered for establishing a link between activities and metrics can be any of the exemplary business condition metrics described herein.

### Example 30

### Exemplary Spreadsheet Implementation

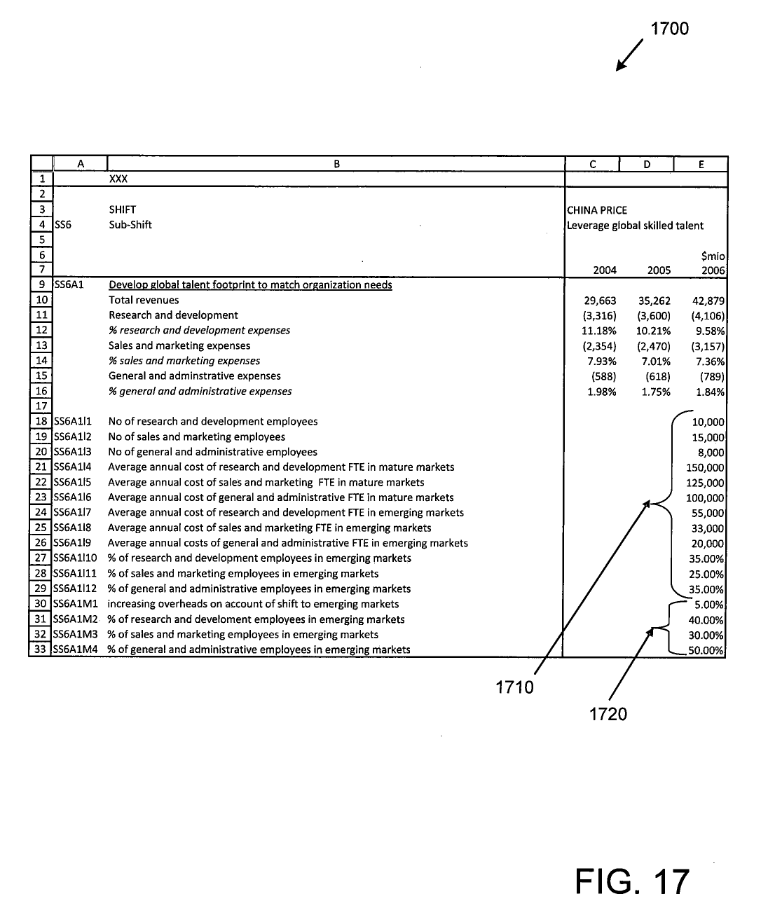

Spreadsheet tools or other business value software may be used to perform the financial impact of each activity on business entity as explained below in connection with FIGS. 17, 18, 19, and 20, respectively. A spreadsheet can be a software tool having at least a two dimensional array of cells in which a user may enter data or formulas in the cells to facilitate entry, calculating results and recording values. Some spreadsheets permit data of nearly any type to be entered in a cell including a number, a mathematical formula, alphanumeric variable, test, a graphic, an audio or video clip, or an object of any type such as known in the object oriented programming arts. The MICROSOFT EXCEL software (EXCEL is a trademark of Microsoft Corp., Redmond, Wash.) is an example of spreadsheet software currently available which may be used for such calculations.

### Example 31

### Exemplary Spreadsheet Pages

In FIG. 17, there is shown an example of a spreadsheet page 1700 containing two types of inputs that a user needs to specify such as actual financials for each metric as shown in step 1710 and the improvements on the chosen metrics as depicted in step 1720.

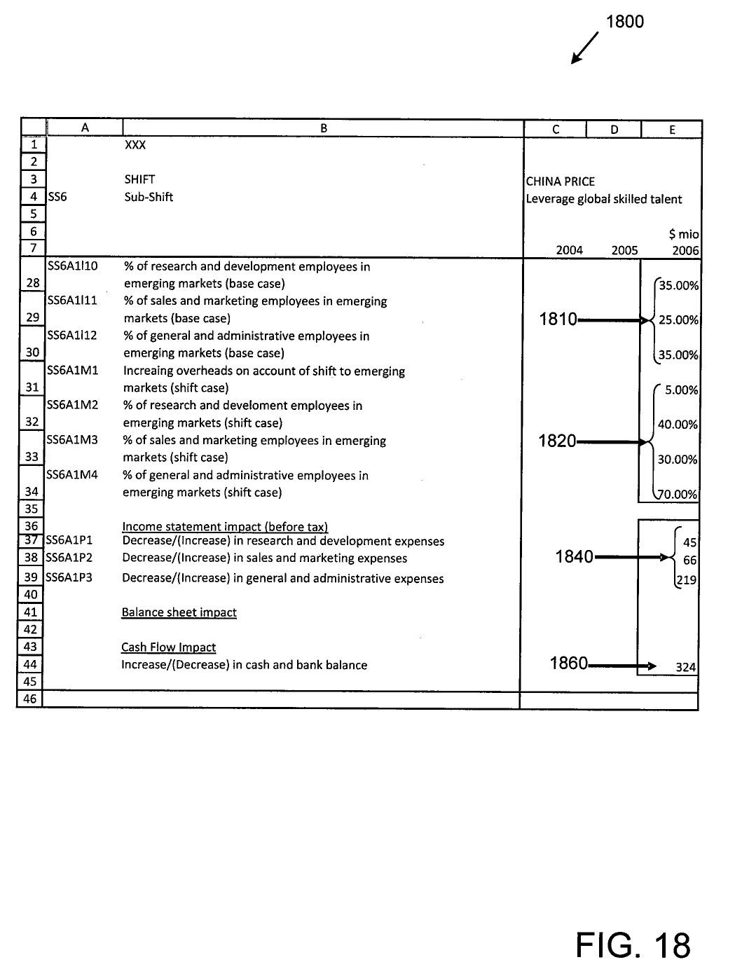

Referring to FIG. 18, there is shown an example of a spreadsheet page 1800 containing the financial impact of “Leverage Global Skilled Talent” Activity on business entity. In step 1810, a user will specify the values for each metric. In step 1820, a user has to provide the improvements that the user wishes to use in one or multiple metrics. Thus, the user is able to view the financial impact on Income Statement, Balance Sheet and Total Financial Cash Flow as depicted in 1840 and 1860 respectively.

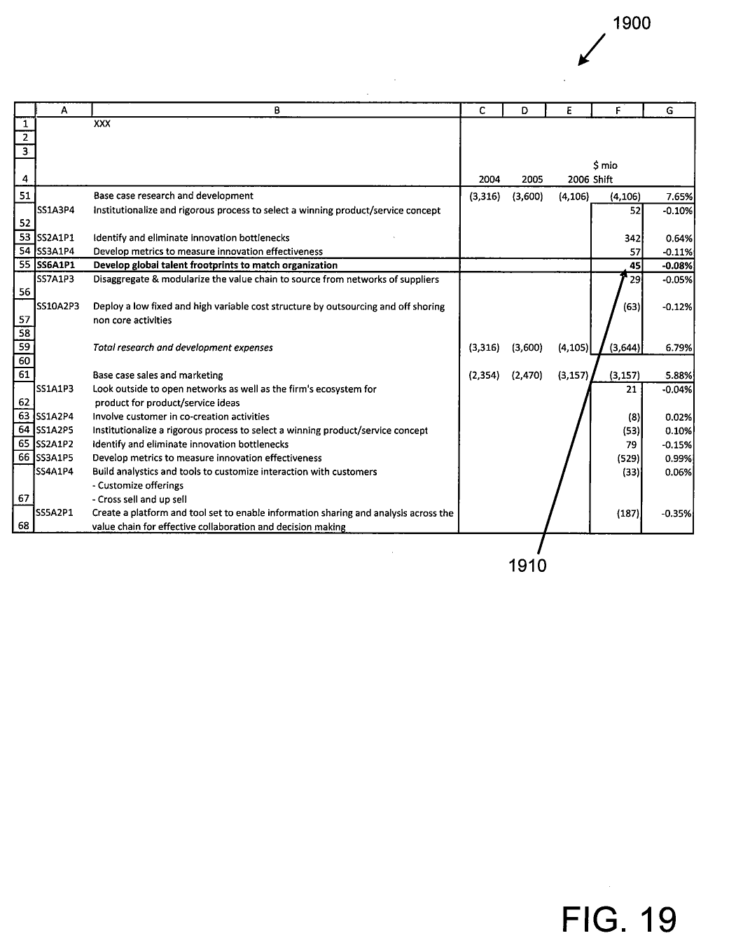

In FIG. 19, there is shown an example of a spreadsheet page 1900 containing the summarized view of the financial impact of all the activities that define a business entity. At 1910, the financial impact of “Develop global talent foot print to match organization” activity on the Income Statement is shown.

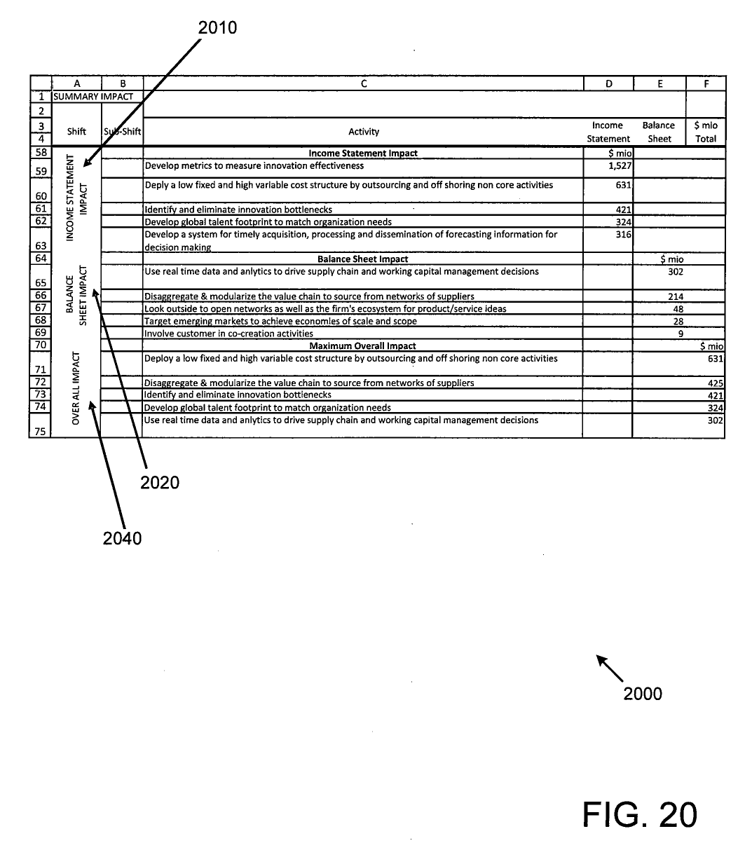

In FIG. 20, there is shown an example of a spreadsheet page 2000 containing the prioritized activities that have financial impact on Income Statement, Balance Sheet and Total Financial Cash Flow respectively. At 2010, the prioritized activities that a business entity needs to take up under the business environment based on the Income Statement. Similarly. The activities are prioritized based on Balance Sheet and Total Financial Cash Flow at 2020 and 2040 respectively.

### Example 32

### Exemplary Spreadsheet Arrangement

An implementation in a spreadsheet can track the various activities according to sub-shift. For example, the activities for a sub-shift can be stored on different sheets within a spreadsheet workbook. The financial condition of the business entity can be stored on a separate sheet in the workbook. The business condition metrics and shifted business condition metrics can be stored on a separate sheet in the workbook. The financial impact can then be stored on a separate sheet, and the prioritized activities can appear thereon or on a separate sheet.

### Example 33

### Exemplary Naming Convention

To track the various values in the model, a naming convention can be adopted. For example, sub-shifts can have a designation that uniquely identifies them (e.g., “SSx”), and activities can similarly have a unique identifier (SSxAn). Shifted metrics for the activities be given still further identifiers (SSxAnMm), so that an identifier for a particular shifted metrics could be “SS3A2M1.” The metric identifier thus includes the identifier for the associated sub-shift and the identifier for the associated activity.

Such a naming convention can be useful in software or spreadsheets to provide a more user-friendly organization of a large number of activities and related metrics.

### Example 34

### Exemplary Rules

In any of the examples herein, a rule can accept any number of inputs and produce one or more outputs (e.g., a value, such as impact on cost of sales). Operators and functions can be included in the rule.

### Example 35

### Exemplary Rules in Spreadsheet Implementation

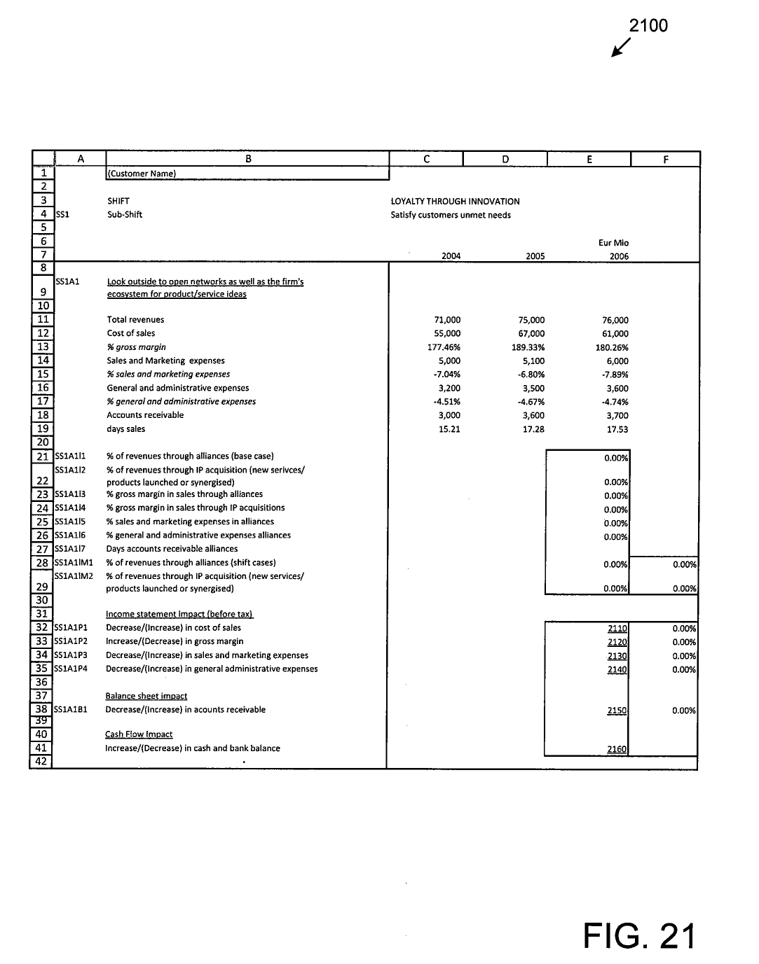

FIG. 21 is an exemplary spreadsheet page implementing modeling for the sub-shift “satisfy customers unmet needs.” In the example, the following formulas implement rules 2110-2160 to determine impact on financial condition elements for the activity “Look outside to open networks as well as the firm's ecosystem for product/service ideas.”

Rules 2110-2140 model income statement impact. Rule 2110 takes the following form to determine “Decrease/(Increase) in cost of sales”:

=E33

Rule 2120 takes the following form to determine “Increase/(Decrease) in gross margin”:

=((1−E28)*(E13−E21*E23)/(1−E21)+(E28*E23))*E1−E11−E12+((1−E29)*(E13−E22*E24)/(1−E22)+E29*E24)*E1−E11−E12

Rule 2130 takes the following form to determine “Decrease/(Increase) in sales and marketing expenses”:

=−((1−$E$28)*(E15−E25*$E$21)/(1−$E$21)+E25*$E$28)*E11−E14

Rule 2140 takes the following form to determine “Decrease/(Increase) in general and administrative expenses”:

=−((1−$E$28)*(E17−E26*$E$21)/(1−$E$21)+E26*$E$28)*E11−E16

Rule 2150 models balance sheet impact and takes the following form to determine “Decrease/(Increase) in accounts receivable”:

=(E19−((1−E28)*(E19−E21*E27)/(1−E21)+E27*E28))*E11/360

Rule 2160 models cash flow impact and takes the following form to determine “Increase/(Decrease) in cash and bank balance”:

=SUM(E33:E38)

### Example 36

### Exemplary Methods and Systems

An exemplary method can include identifying a list of shifts required by a business entity to perform, defining a list of sub-shifts for each shift, describing a list of activities to each sub-shift for executing an operational action by a business entity, defining a list of metrics for each activity and constructing a link between activities and metrics for prediction of financial impact of the activity of the business framework within the business entity in the business environment. The method further includes gathering past financial data and current financial data of business entity and connecting each metric with one or more line items of income statement and balance sheet.

In accordance with another aspect, an exemplary system predicts the financial impact of the implementation of a business framework for a business entity. The system includes a shift module containing a set of shifts required by a business entity to perform, a sub-shift module containing a set of sub-shifts defined for each shift, an activity module describing at least one activity to each sub-shift for executing an operational action by a business entity, a metrics module containing a set of metrics defined for each of the activities, a user input interface for accepting user-specific input on financials of each of the metrics and for accepting user-specific input for improvement in at least one of the metrics and a data simulator adapted to construct a link between at least one of the activities of the activity module with at least one of the corresponding metrics of the metrics module for predicting the financial impact of the activity in the business entity. The data simulator further recasts the income statement, balance sheet and total financial cash flow based on the impact of the impact of the activities. The data simulator also prioritizes the activities that a business entity needs to perform to compete in a flattening business environment.

### Example 37

### Exemplary Features

A method and system to predict the financial impact of the implementation of a business framework for a business entity is disclosed. The method can include the actions of identifying a list of shifts required by a business entity to perform, defining a list of sub-shifts for each shift, describing a list of activities to each sub-shift for executing an operational action by the business entity, defining a list of metrics for each activity and constructing a link between activities and metrics for prediction of financial impact of the activity of the business framework within the business entity in the business environment. The method can further include gathering past financial data and current financial data of the business entity and connecting respective metrics (e.g., each metric) with one or more line items of income statement, balance sheet.

### Example 38

### Exemplary Computing Environment

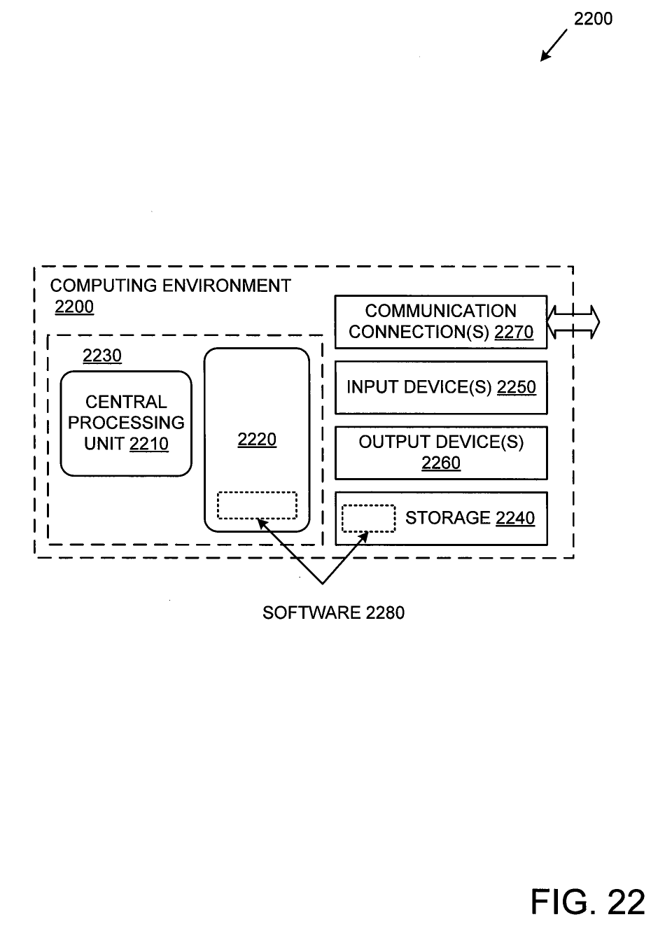

One or more of the above-described techniques may be implemented in or involve one or more computer systems. FIG. 22 illustrates a generalized example of a suitable computing environment 2200 in which the described techniques can be implemented. The computing environment 2200 is not intended to suggest any limitation as to scope of use or functionality, as the technologies may be implemented in diverse general-purpose or special-purpose computing environments. A mainframe environment will be different from that shown, but can also implement the technologies and can also have computer-readable media, one or more processors, and the like.

With reference to FIG. 22, the computing environment 2200 includes at least one processing unit 2210 and memory 2220. In FIG. 22, this basic configuration 2230 is included within a dashed line. The processing unit 2210 executes computer-executable instructions and may be a real or a virtual processor. In a multi-processing system, multiple processing units execute computer-executable instructions to increase processing power. The memory 2220 may be volatile memory (e.g., registers, cache, RAM), non-volatile memory (e.g., ROM, EEPROM, flash memory, etc.), or some combination of the two. The memory 2220 can store software 2280 implementing any of the technologies described herein.

A computing environment may have additional features. For example, the computing environment 2200 includes storage 2240, one or more input devices 2250, one or more output devices 2260, and one or more communication connections 2270. An interconnection mechanism (not shown) such as a bus, controller, or network interconnects the components of the computing environment 2200. Typically, operating system software (not shown) provides an operating environment for other software executing in the computing environment 2200, and coordinates activities of the components of the computing environment 2200.

The storage 2240 may be removable or non-removable, and includes magnetic disks, magnetic tapes or cassettes, CD-ROMs, CD-RWs, DVDs, or any other computer-readable media which can be used to store information and which can be accessed within the computing environment 2200. The storage 2240 can store software 2280 containing instructions for any of the technologies described herein.

The input device(s) 2250 may be a touch input device such as a keyboard, mouse, pen, or trackball, a voice input device, a scanning device, or another device that provides input to the computing environment 2200. For audio, the input device(s) 2250 may be a sound card or similar device that accepts audio input in analog or digital form, or a CD-ROM reader that provides audio samples to the computing environment. The output device(s) 2260 may be a display, printer, speaker, CD-writer, or another device that provides output from the computing environment 2200.

The communication connection(s) 2270 enable communication over a communication means to another computing entity. The communication means conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

Implementations may be described in the general context of computer-readable media. Computer-readable media are any available media that may be accessed within a computing environment. By way of example, and not limitation, within the computing environment 2200, computer-readable media include memory 2220 and storage 2240, and combinations of any of the above.

The programs, processes, or methods described herein need not be related or limited to any particular type of computing environment. Various types of general purpose or specialized computing environments may be used with or perform operations in accordance with the teachings described herein. Elements of the described embodiments shown in software may be implemented in hardware and vice versa.

### Methods in Computer-Readable Media

Any of the methods described herein can be implemented by computer-executable instructions in one or more computer-readable media (e.g., computer-readable storage media or other tangible media). The technologies described herein can be implemented in a variety of programming languages.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of these claims.

We claim:

1. A computer-implemented method of modeling impact of a business framework on a business entity, the method comprising:
receiving data of financial condition of the business entity;
receiving observed business condition metrics of the business entity;
generating a modeled impact on the financial condition of the business entity if the business framework were to be adopted by the business entity, wherein the generating comprises applying shifted business condition metrics to the financial condition in light of the observed business condition metrics via rule sets; and
outputting the modeled impact on the financial condition of the business entity as a modeled financial impact on the financial condition of the business entity.

2. The method of claim 1 wherein the generating comprises:
for a plurality of business activities, modeling financial impact of respective of the business activities according to shifted business condition metrics defined as exclusively associated with respective of the business activities.

3. The method of claim 2 wherein:
a shifted business condition metric measures effectiveness of engaging in the activity associated with the shifted business condition metric.

4. The method of claim 2 wherein:
modeling financial impact comprises applying a rule set of one or more rules for an activity, wherein at least one of the rules accepts a base case business condition metric and a shifted business condition metric corresponding to the base case business condition metric as input; and
a shifted business condition metric serves as an input in a rule set of at most one activity.

5. The method of claim 2 further comprising:
prioritizing the business activities according to respective modeled financial impact on of the respective business activities; and
outputting prioritized business activities.

6. The method of claim 5 wherein outputting prioritized business activities comprises:
separately displaying a top n business activities out of the business activities according to modeled financial impact of the respective business activities.

7. The method of claim 1 wherein generating the modeled impact on financial condition comprises:
modeling impact on a plurality of financial condition elements; and
combining the financial condition elements into a modeled impact on income statement or balance sheet of the business entity.

8. The method of claim 1 wherein the generating comprises:
for respective business activities specified in the business framework, performing (a)-(b) for the business activity:
(a) modeling impact on one or more financial condition elements of the business entity if the business activity were to be adopted or improved via one or more rule sets configured to accept values for one or more business condition metrics and at least one shifted business condition metric corresponding to at least one of the one or more business condition metrics and further configured to output one or more values indicating impact on the one or more financial condition elements of the business entity;
(b) combining the impact on the one or more financial condition elements into an overall impact on balance sheet and income statement for the business entity if the business activity were to be adopted or improved.

9. One or more computer-readable media having computer-executable instructions causing a computer to perform the method of claim 1.

10. A computer-implemented method of indicating a subset of business activities, specified in a business framework, for consideration by a business entity, the method comprising:
for respective business activities specified in the business framework, performing (a)-(b) for the business activity:
(a) modeling impact on one or more financial condition elements of the business entity if the business activity were to be adopted or improved via one or more rule sets configured to accept values for one or more business condition metrics and at least one shifted business condition metric corresponding to at least one of the one or more business condition metrics and further configured to output one or more values indicating impact on the one or more financial condition elements of the business entity;
(b) combining the impact on the one or more financial condition elements into an overall impact on balance sheet and income statement for the business entity if the business activity were to be adopted or improved;
based on overall impact on balance sheet, displaying a first proper subset of the business activities as to be considered for adoption or improvement by the business entity; and
based on overall impact on income statement, displaying a second proper subset of the business activities as to be considered for adoption or improvement by the business entity.

11. The computer-implemented method of claim 10 wherein the shifted business condition metrics are defined as mutually exclusive for the business activities and no shifted business condition metric is used as input for a rule of another business activity.

12. A system for prioritizing a plurality of business activities comprising:
a plurality of rule sets for respective of the business activities, wherein rules of the rule sets accept inputs comprising one or more financial conditions of a business entity, a base case business condition metric for the business entity, and a shifted business condition metric corresponding to the base case business condition metric and adjusted to reflect adoption or improvement of a business activity by the business entity, wherein rules of the rule sets generate outputs indicative of a modeled financial impact on a business entity if a business activity were to be adopted or improved;
a plurality of aggregators configured to accept modeled financial impact as a plurality of impacts on financial condition elements and output an aggregated modeled financial impact; and
a prioritizer configured to display top ranked business activities according to aggregated modeled financial impact of respective of the business activities.

13. A method for predicting financial impact on a business entity of a business framework having a list of shifts with respective defined sub-shifts with respective activities, the method comprising:
identifying at least one activity for executing an operational action by said business entity;
providing at least one metric for the activity; and
constructing a link between the activity and the metric for predicting financial impact of the activity of the business framework on the business entity.

14. The method of claim 13 further comprising:
recasting of income statement, balance sheet, and total financial cash flow resulting from financial impact of the at least one activity.

15. The method of claim 13 further comprising:
prioritizing the activities by recasting income statement, balance sheet, and total financial cash flow.

16. The method of claim 13, wherein the activities and the metrics are mutually exclusive and collectively exhaustive.

17. The method of claim 13 further comprising:
gathering past financial data and current financial data of business entity.

18. A system for predicting financial impact on a business entity of a business framework defining a set of shifts required for the business entity to perform and a set of sub-shifts defined for each shift, the system comprising:
an activity module describing at least one activity for each sub-shift for executing an operational action by the business entity;
a metrics module containing a set of metrics defined for each of the activities;
a user input interface for accepting user-specific input on financials of each of said metrics and for accepting user-specific input for improvement in at least one of the metrics; and
a data simulator adapted to construct a link between at least one of the activity of the activity module with at least one corresponding metric of the metrics module for predicting financial impact of the activity on the business entity.

19. The system according to claim 18 wherein the shifts are selected from the group consisting of: loyalty through innovation, make money from information, China price and winning in turns.

20. The system according to claim 18 wherein the data simulator is configured to connect each metric from the metrics module with a line items of income statement or balance sheet or both.

21. The system according to claim 18 wherein the data simulator is configured to recast income statement, balance sheet, and total financial cash flow resulting from financial impact of the at least one activity.

22. The system according to claim 18 wherein the data simulator is configured to prioritize the activities based on a modified income statement, balance sheet, and total financial cash flow.

23. The system according to claim 18 wherein the user input interface for accepting user-specific input on financials gathers past financial data and current financial data of the business entity.
